(19) United States
(12) Patent Application Publication
(10) Pub. No.: US 2026/0171049 A1
(43) Pub. Date: Jun. 18, 2026

(54) RETRACTABLE GUITAR RAMP

(71) Applicant: Fodera Guitar Partners, LLC, Brooklyn, NY (US)

(72) Inventor: Robert Trama, Brooklyn, NY (US)

(21) Appl. No.: 18/978,227

(22) Filed: Dec. 12, 2024

(51) Int. Cl. G10D 3/06; G10D 1/08

(52) U.S. Cl. CPC G10D 3/06; G10D 1/08

(57) ABSTRACT

A retractable guitar ramp that comprises two platforms. An upper platform that is positioned above a lower platform. The lower platform is static and disposed on the surface of a guitar below guitar strings. The upper platform moves between a first position that is extended and second position that is retracted. In the first position, the upper platform is disposed a distance from the lower platform. In a second position, the upper platform abuts the lower platform as it is pressed down; here, the lower platform and the upper platform will stay adjacent the lower platform in a compressed manner. The upper platform readily moves up and down with a biasing mechanism such as pressure as it is vertically extendable and retractable in comparison to the lower platform.

### FIELD OF THE INVENTION

The present disclosure is broadly directed to musical instrument accessories. Specifically, the present invention is directed to devices for use with string instruments.

### BACKGROUND OF THE INVENTION

The guitar ramp, also called a finger ramp, is an object made of wood, an inert material, or a combination of inert materials, placed on a stringed instrument between the strings and body of the instrument, located in a position where the strings would be plucked. The ramp is intended to decrease the distance between the instrument’s body and strings, creating less depth for the user’s finger or plectrum underneath the strings.

There are several techniques of playing a guitar or bass, one of which is fingerstyle. Fingerstyle means a player plucks strings directly with their fingertips, thumb, fingernails or with picks on their fingers. The vertical distance between the body of an instrument and its strings determines how much space there is for a player’s fingers while playing fingerstyle. A greater distance generally allows for wider dynamic range in fingerstyle playing, while less distance between the strings and body can facilitate faster and more intricate playing, with a decrease in dynamic range. While the depth stop effect of the traditional guitar ramp is beneficial to enhance certain styles of performance, it inhibits others. Since traditional ramps are affixed to the instrument semi-permanently with double sided adhesive tape or other methods, ramps are not easily removable. To enjoy the benefits of a traditional guitar ramp while avoiding its drawbacks, a player would need to use two guitars, one with a ramp and one without.

What is desired is a ramp that allows a player to selectively utilize the height of the ramp, or the distance between the strings and the body of the instrument. For instance, the ramp will be in place when fast play is necessary and then removed when a more dynamic style of play is required in the performance. A ramp is needed that can be selectively used without stopping the performance, that has multiple positions allowing for different styles of play. What is further desired is a ramp that snaps up and snaps down between two heights. What is needed is a spring-loaded ramp that is retractable, that can easily be retracted by pressing the ramp down with one finger, allowing one to play and facilitate different styles of playing with ease.

### SUMMARY OF THE INVENTION

The present invention discloses a retractable guitar ramp comprising a lower platform and upper platform. The upper platform is mechanically connected to the lower platform. The upper platform is vertically extendable and retractable. The upper platform in fixable in more than one position in relation to the lower platform. In some embodiments the upper platform hasa first, extended position, wherein the upper platform is positioned above and a distance from the lower platform. In some embodiments, upper platform has a second, retracted position, wherein the upper platform is adjacent and compressed against the lower platform. In some embodiments, pressure is applied to the upper platform to move the upper platform in comparison to the lower platform.

A guitar ramp comprising a lower platform and an upper platform, the upper platform mechanically connected to the lower platform. The upper platform movable along a perpendicular axis, vertically, relative to the lower platform, the upper platform movable between a first position and a second position. In the first position, the upper platform is disposed a distance above the lower platform. In the second position, the upper platform is flush with the lower platform. In some embodiments, pressure is applied to the upper platform moving the upper platform between the first position and the second position. In some embodiments, the upper platform is fixable in more than one position in relation to the lower platform and wherein the upper platform moves between positions by an actuating mechanism. In some embodiments, the upper platform moves between the first position and the second position by an actuating mechanism. In one instance, the actuating mechanism includes a biasing mechanism and said biasing mechanism includes at least one spring and at least one tension line.

### DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1 shows a retractable ramp 100 of the present invention disposed on a musical instrument.

FIG. 2A shows the ramp of FIG. 1 in a first position.

FIG. 2B shows the ramp of FIG. 1 in a second position.

FIG. 3A shows a cutaway view of the ramp shown in FIG. 2A in the first position.

FIG. 3B shows a cutaway view of the ramp shown in FIG. 2B in the second position.

To facilitate understanding, identical reference numerals have been used where possible, to designate identical elements that are common to the figures. It is contemplated that elements and features of one embodiment may be beneficially incorporated in other embodiments without further recitation.

### DETAILED DESCRIPTION OF THE INVENTION

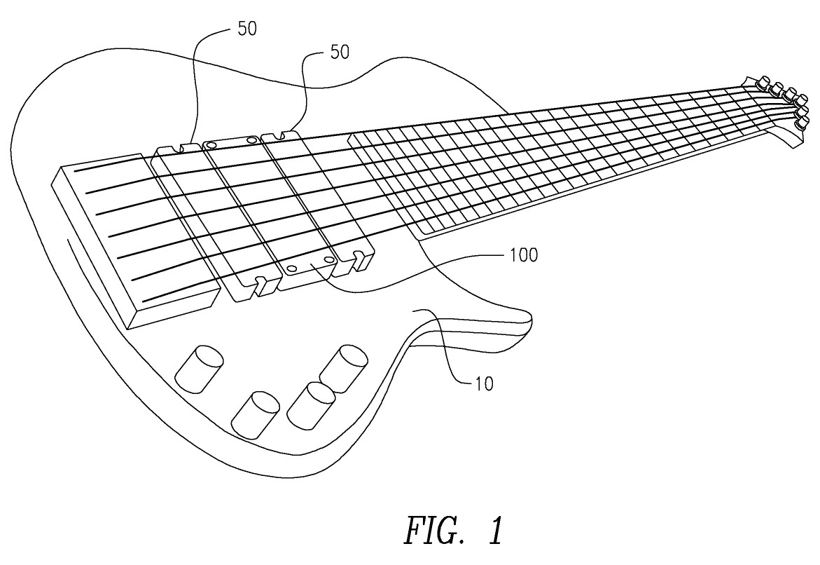

FIG. 1 shows an embodiment of a retractable ramp 100 disposed on a body of a musical instrument 10. In the embodiment shown, the ramp 100 may be placed between two pickups 50. In another embodiment the retractable ramp 100 may be placed on either side of a single pickup. In some embodiments of musical instruments 10 there may be no pickups protruding from the surface of the musical instrument 10 or more than two pickups 50. In some embodiments, the retractable ramp 100 may be disposed in any desired position between the fretboard and the bridge of the musical instrument 10 that does not interfere with the placement of any pickups 50. The ramp 100 may be made of an inert material, such as wood, or a combination of inert materials. In some embodiments the ramp may be made from an inert material having a wood cap or veneer.

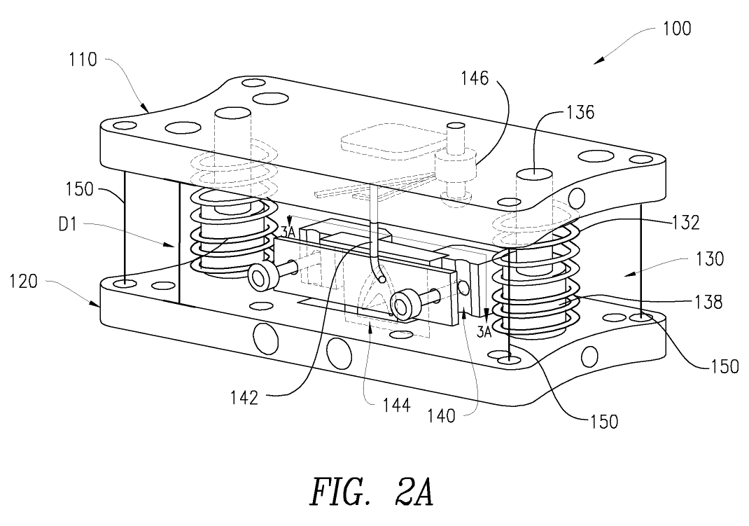

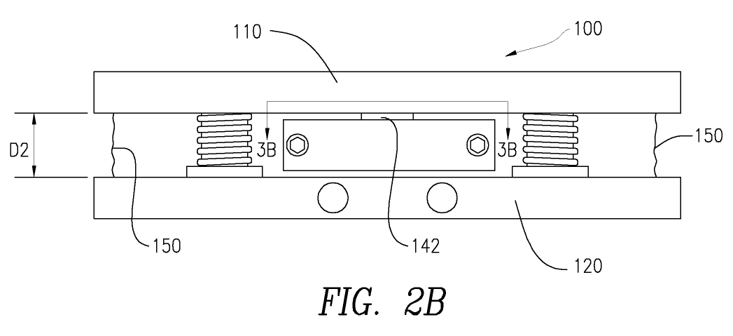

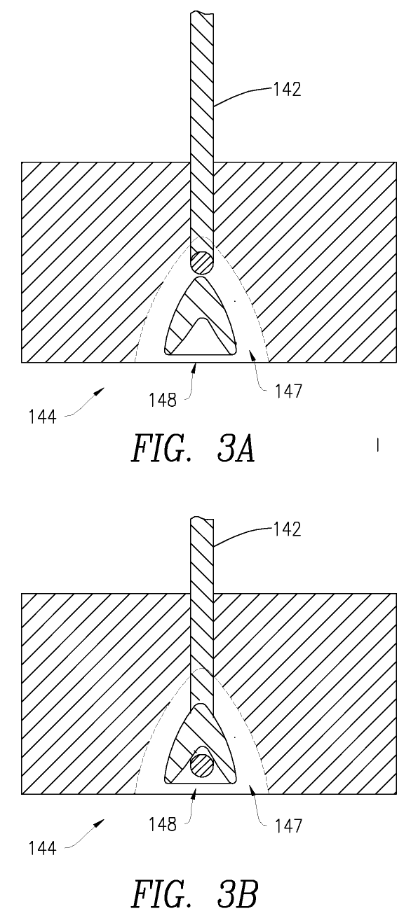

Looking now at FIGS. 2A and 2B, the ramp 100 is shown having an upper platform 110 and a lower platform 120. The lower platform 120 is static and is configured to be attachable to the musical instrument 10. The upper platform 110 is movable along a perpendicular axis to the lower platform 120. In some embodiments the upper platform 110 is movable vertically between a first, raised or extended position at a distance, D1, from the lower platform 120, or "on/up position" and a second, lowered or retracted position at a second distance, D2, from the lower platform 120, or "off/down position." See FIGS. 2A and 2B, respectively.

FIG. 1 shows the ramp 100 in the first, extended position D1. In this first position D1, the upper platform 110 is located above and a distance from the lower platform 120. From the first position D1, the upper platform 110 is lowerable and adjustable between the first position D1 and the second position D2. The upper platform 110 can be lowered and be fixed in the retracted position D2. In the retracted position, the upper platform 110 may be flush with the lower platform 120 and is adjacent and compressed against the lower platform 120. To return the upper platform 110 from the retracted position D2 to the first position D1 an actuating mechanism may be used. In some embodiments the upper platform 110 may not be flush with the lower platform 120 in the retracted position D2. In some embodiments, the upper platform 110 may be infinitely adjustable between the first position D1 and the second position D2, or the upper platform 110 may be adjustable in defined increments between the first position D1 and the second position D2, either by way of the mechanisms described herein or otherwise.

The actuating mechanism may be used to cycle between the first position D1 and the second position D2. In some embodiments, the actuating mechanism may use pressure to activate. For instance, the actuating mechanism may employ springs 132 that surround pin 136 and sleeve bearing 138, a block 140, a spring guide pin 142, a channel or path 144 having a top position 147 and a notch 148 disposed in the block 140, a torsion spring 146, and tension lines 150. See FIGS. 2A and 2B.

The springs 132 may be positioned on either end of the ramp 100 and ride on the pins 136. The pins 136 are configured to enter the sleeve bearing 138 and travel vertically through the sleeve bearings 138. In one embodiment, the pins 136 can move through the sleeve bearings 138 with minimal friction or chatter. The spring guide pin 142 travels on a path 144, being, in one embodiment, defined from the top position 147 around the channel to the notch 148 that is machined in block 140. The spring guide pin 142 traveling along the path 144 allows the ramp 100 to shift between a locked, first position D1 where the pin 142 is at the top position 147 and a locked, second position D2 where the pin 142 is fixed in the notch 148. The torsion spring 146 is configured to apply directional pressure to the guide pin 142 allowing the guide pin 142 to travel vertically along the path 144 of the block 140 between the locked, first position D1 at the top position 147 and the locked, second position D2 at the notch 148 so that the guide pin 142 does not jump out of the channel or path 144.

The tension lines 150 may be of high strength and used at the corners of the ramp 100 to help maintain stability and rigidity utilizing the principle of tensegrity, also known as floating compression. In one embodiment, at least one spring 132 and at least one tension line 150 comprise a biasing mechanism to stabilize the position of the upper platform 110. In other embodiments, other elements of the actuating mechanism may also be included in the biasing mechanism.

In one example of use, from the first position D1, the upper platform 110 may be lowered from the first position D1 to the second position D2 by applying downward force to the upper platform 110 until the top surface of the upper platform 110 drops below the surface of the body 10 and locks in place. By applying a downward force to the upper platform 110, the torsion spring 146 applies directional pressure to the spring guide pin 142 allowing the spring guide pin 142 to travel vertically along the path 144 from the top position 147 and engage the notch 148 once the upper platform 110 is sufficiently depressed and the spring guide pin 142 drops below the notch 148. Specifically, in the first position D1, the guide pin 142 engages the top position 147 of the path 144. When pressure is applied to the upper platform 110, the guide pin 142 travels downward along the path 144 while the torsion spring 146 applies directional pressure to the guide pin 142 to direct the guide pin 142 to engage the notch 148 and remain fixed in place. The springs 132 that surround the sleeve bearings 138 apply upward pressure to the upper platform 110 which allows the upper platform 110 to stay fixed in a second position D2 whereby the spring guide pin 142 is engaged with the notch 148 and the retaining block 140 keeps pressure on the guide pin 142 preventing it from disengaging with the notch 148 and traveling freelyin path 144.

When downward pressure is applied to the upper platform 110 fixed in the second position D2, the upper platform may be raised to the first position D1. Here, downward pressure is applied to the upper platform 110, in a similar manner as to lower the upper platform 110 to the second position D2, pushing the upper platform 110 downward allowing the guide pin 142 to disengage from the notch 148 and travel freely along the path 144 to the top 147 of the path 144. Simultaneously, the torsion spring 146 applies pressure to the guide pin 142 for it to travel along the path 144 to engage the top 147, also called the detracting path, in the guide block 140, rather than re-engaging the notch 148, while the sleeve bearing 138 and compressed springs 132 applies upward pressure to the upper platform 110 to return the upper platform 110 to the first position D1. The guide pin 142 sitting engaging the top 147 of the track 144 prevents the top platform 110 from going past the first position D1. The lines 150 apply tension to each corner of the ramp 100 between the top platform 110 and the bottom platform 120, stabilizing the top platform 110 in the first position D1.

In other embodiments, the actuating mechanism may include mechanical assistance between retracted and extended positions such as latch and release with a click system. In one embodiment, the click system includes spring-loaded push down latch and release devices. A click system may be engaged when the upper platform 110 is depressed into or below the retracted, second position D2. The click system is disengaged when the upper platform 110 is pushed again and the upper platform 110 ascends to its extended, first position D1. In other embodiments, the actuating mechanism may include mechanisms such as but not limited to sensible tactile detents and audible clicks.

In some embodiments, fasteners may be utilized to keep the sleeve bearings 138 and steel pins 136 locked into the body of the ramp 100. Fasteners may also be bonded to each line 150, creating tension at the four corners of the ramp 100 and create a stable top surface of the upper platform 110. Fasteners may also be used to mount the retractable ramp 100 to the body of the musical instrument 10. Here the fasteners, for example, but not limited to, machine or wood screws, would enter a back of the body of the musical instrument 10 and fasten the ramp 100 to an inside cavity of the musical instrument 10. Another way to attach the ramp 100 to the instrument 10 would be to use magnets or the like embedded in the lower platform 120 and a steel plate that is attached into a bottom of a cavity on the musical instrument 10. In other embodiments, the ramp 100 may be attached via other mechanisms that allow for easy removal and maintenance.

In another embodiment, the actuating mechanism may employ magnets. Here, the ramp 100 may be made of wood, plastic, or other inert materials, and is attached to the actuating mechanism magnetically or the like that are embedded in the upper platform 110 and a bottom or underside of the ramp 100 in an offset pattern. Magnets may also be placed within a wood or plastic cover or top of the ramp 100 and the bottom, or vice versa, where metal plates are placed on top and magnets on the bottom. Thisallows the ramp 100 to only connect to the actuating mechanism in one direction and prevents the ability of attaching the ramp 100 incorrectly which would reverse the movable upper platform 110 of the ramp 100 and the stationary lower platform 120.

In one embodiment, the surface of the ramp 100 is not flat. The ramp 100 is a section of a compound radius or cone which is dictated by the intonation, height and gauge of each string. In essence, the ramp 100 has a bass side, designed for thicker gauge strings, and treble side, designed for thinner gauge strings. In one embodiment, proper orientation can be determined by using four magnets on the surface of the upper platform 110 that are not symmetrically placed and corresponding magnets on the underside/bottom of the lower platform 120 of the ramp 100 that only allows the ramp 100 to attach in proper orientation. This attachment mechanism allows the ramp 100 to be easily removed for maintenance or any other reason.

In a preferred embodiment, a method for operating ramp 100 begins by applying a downward force to the upper platform 110. The upper platform 100 is mechanically connected to a lower platform 120. The upper platform 110 begins fixed in a position at a first distance from the lower platform 120 and is vertically extendable and retractable relative to the lower platform 120.

Applying the downward force to the upper platform 110 activates an actuating mechanism that moves the upper platform 110 along a perpendicular axis to the lower platform 120. Beginning at a first distance D1, lowering the upper platform 110 a sufficient distance in relation to the lower platform 120 by way of the actuating mechanism fixes the upper platform 110 in a position at a second distance D2 from the lower platform 120. The second distance D2 is smaller than the first distance D1.

In some embodiments, the actuating mechanism includes a biasing mechanism to control the distance between D1 and D2 and maintains stability of the upper platform 110. In some embodiments the biasing mechanism comprises at least one spring 132 and at least one tension line 150 that interact providing opposite forces to stabilize the upper platform 110 and allow for the operability described herein.

While specific embodiments of the invention have been described and illustrated, such embodiments should be considered illustrative of the invention only and not as limiting the invention as construed in accordance with the accompanying claims. One of ordinary skill in the art could alter the above embodiments or provide insubstantial changes that may be made without departing from the scope of the disclosure.

I claim:

1. A retractable guitar ramp comprising:
a lower platform, the lower platform is disposed on the surface of a guitar below guitar strings; and
an upper platform, the upper platform is mechanically connected to the lower platform and the upper platform is vertically extendable and retractable relative to the lower platform;
wherein the upper platform is fixable in more than one position in relation to the lower platform.

2. The retractable guitar ramp of claim 1, wherein the upper platform moves between a first, extended position and a second, retracted position.

3. The retractable guitar ramp of claim 2, wherein in the first, extended position, the upper platform is positioned above and a distance from the lower platform, and in the second, retracted position, the upper platform is positioned at a second distance from the lower platform.

4. The retractable guitar ramp of claim 3, wherein the second distance is smaller than the first distance.

5. The retractable finger ramp of claim 2, wherein the upper platform is movable between the first, extended position and the second, retracted position by applying pressure to the upper platform.

6. A guitar ramp comprising:
a lower platform; and
an upper platform, the upper platform is mechanically connected to the lower platform and the upper platform is vertically extendable and retractable relative to the lower platform,
wherein the upper platform is fixable in more than one position in relation to the lower platform, and
wherein the upper platform moves between positions by an actuating mechanism.

7. The guitar ramp of claim 6, wherein the upper platform moves between a first, extended, position and a second, retracted, position.

8. The guitar ramp of claim 6, wherein in the first position, the upper platform is disposed a distance from the lower platform and in the second position, the upper platform is positioned at a second distance from the lower platform and wherein the second distance is smaller than the first distance.

9. The guitar ramp of claim 8, wherein in the second position the upper platform is flush with the lower platform.

10. The ramp of claim 6, wherein pressure is applied to the upper platform to activate the actuating mechanism to move the upper platform.

11. The ramp of claim 6, wherein the actuating mechanism includes a biasing mechanism.

12. The ramp of claim 11, wherein the biasing mechanism includes at least one spring and at least one tension line.

13. A method for operating a retractable finger ramp for stringed musical instruments, the method comprising:
applying a downward force to an upper platform, the upper platform mechanically connected to a lower platform, wherein the upper platform is fixed in a position at a first distance from the lower platform and is vertically extendable and retractable relative to the lower platform,
activating an actuating mechanism that moves the upper platform along a perpendicular axis to the lower platform, and
fixing the upper platform in a position at a second distance from the lower platform wherein the second distance is smaller than the first distance.

14. The method of claim 13, wherein the actuating mechanism includes a biasing mechanism.

15. The method of claim 14, wherein the biasing mechanism comprises at least one spring and at least one tension line.
